(19) United States
(12) Patent Application Publication
(10) Pub. No.: US 2023/0185831 A1
(43) Pub. Date: Jun. 15, 2023

(54) SATELLITE DATA FOR ESTIMATING SURVEY COMPLETENESS BY REGION

(71) Applicant: Chris Shughrue, Canaan, NY (US)

(72) Inventor: Chris Shughrue, Canaan, NY (US)

(21) Appl. No.: 17/546,701

(22) Filed: Dec. 9, 2021

(51) Int. Cl. G06F 16/29; G06N 20/20

(52) U.S. Cl. CPC G06F 16/29; G06N 20/20

(57) ABSTRACT

Example systems, devices, media, and methods are described for predicting the total number of places or points of interest in a particular region based on nighttime lights data captured by orbiting satellites. The method includes obtaining a satellite dataset that includes a calibrated set of nighttime lights data. The geolocations in the satellite data are correlated to the fixed geolocations of a plurality of regions on the earth. The process includes building and applying a predictive model to nighttime lights data and thereby predict a total place quantity in each identified region. In one example, a predictive machine-learning model includes a random forest of decision trees configured to analyze the satellite-based nighttime lights data and produce a predicted total place quantity. The predictive model can be trained and improved using the nighttime lights data from more populous regions, facilitating more accurate predictions when applied to less populous regions.

### TECHNICAL FIELD

Examples set forth in the present disclosure relate to the field of electronic records and data analysis, including user-provided content. More particularly, but not by way of limitation, the present disclosure describes obtaining satellite data to estimate the completeness of surveys about places located in a region.

### BACKGROUND

Maps and map-related applications include data about points of interest. Data about points of interest can be obtained from surveys or field reports submitted by users, in a practice known as crowdsourcing. Crowdsourcing involves a large, relatively open, and evolving pool of users who can participate and gather real-time data without special skills or training. Crowdsourced data is inherently arbitrary. Regions densely populated with active users may generate a relatively high number of field reports compared to regions with fewer users.

Satellite data captured by various onboard instruments may be obtained from public sources, such as the U.S. Geological Survey, NOAA, and NASA. Satellite-based nighttime lights data can be useful for estimating population and economic activity in a region.

Users have access to many types of computers and electronic devices today, such as mobile devices (e.g., smartphones, tablets, and laptops) and wearable devices (e.g., smartglasses, digital eyewear), which include a variety of cameras, sensors, wireless transceivers, input systems, and displays.

### BRIEF DESCRIPTION OF THE DRAWINGS

Features of the various examples described will be readily understood from the following detailed description, in which reference is made to the figures. A reference numeral is used with each element in the description and throughout the several views of the drawing. When a plurality of similar elements is present, a single reference numeral may be assigned to like elements, with an added lower-case letter referring to a specific element.

The various elements shown in the figures are not drawn to scale unless otherwise indicated. The dimensions of the various elements may be enlarged or reduced in the interest of clarity. The several figures depict one or more implementations and are presented by way of example only and should not be construed as limiting. Included in the drawing are the following figures:

FIG. 1 is an example illustration of a satellite image, displayed using photographic inversion for clarity;

FIG. 2 is an example city map partitioned into a plurality of contiguous regions;

FIG. 3 is a schematic diagram illustrating an example place quantity prediction system of operatively connected elements;

FIG. 4 is a flow chart listing the steps in an example method of predicting place quantity by region;

FIG. 5A is an example subset of field reports suitable for analysis using an example depletion model;

FIG. 5B is a graph illustrating an example linear function generated from the series of data illustrated in FIG. 5A;

FIG. 6 is a diagrammatic representation of a machine in the form of a computer system within which a set of instructions may be executed for causing the machine to perform any one or more of the methods or processes described herein, in accordance with some examples; and

FIG. 7 is block diagram showing a software architecture within which the present disclosure may be implemented, in accordance with examples.

### DETAILED DESCRIPTION

Various implementations and details are described with reference to examples for predicting the total number of places in a region based on nighttime lights data captured by orbiting satellites, e.g., for use in estimating the completeness of surveys about places located in a region. For example, relatively low levels of survey information in a region having relatively high levels of nighttime lights data may indicate that the survey information for that region is incomplete. The process includes building a predictive machine-learning model that includes a random forest of decision trees configured to analyze the satellite-based nighttime lights data and produce a predicted total place quantity.

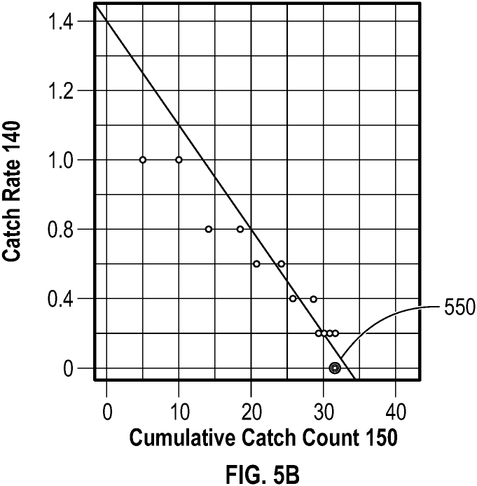

Example methods include applying a geospatial indexing model to identify one or more regions of interest on the ground, obtaining a satellite dataset that includes a calibrated set of nighttime lights data, and correlating the lights data to the identified regions using geolocation. The method includes building and applying a predictive model to nighttime lights data and thereby predict a total place quantity in each identified region. In one example, the predict model is a machine-learning model that includes a random forest of decision trees. The predictive model can be trained and improved using the nighttime lights data from more populous regions, facilitating more accurate predictions when applied to less populous regions. The predictive model can be tested by comparing the predicted results to a known place quantity or a calculated place quantity based on a depletion model (FIG. 5A).

The following detailed description includes systems, methods, techniques, instruction sequences, and computing machine program products illustrative of examples set forth in the disclosure. Numerous details and examples are included for the purpose of providing a thorough understanding of the disclosed subject matter and its relevant teachings. Those skilled in the relevant art, however, may understand how to apply the relevant teachings without such details. Aspects of the disclosed subject matter are not limited to the specific devices, systems, and method described because the relevant teachings can be applied or practice in a variety of ways. The terminology and nomenclature used herein is for the purpose of describing particular aspects only and is not intended to be limiting. In general, well-known instruction instances, protocols, structures, and techniques are not necessarily shown in detail.

The terms “coupled” or “connected” as used herein refer to any logical, optical, physical, or electrical connection, including a link or the like by which the electrical or magnetic signals produced or supplied by one system element are imparted to another coupled or connected system element. Unless described otherwise, coupled or connected elements or devices are not necessarily directly connected to one another and may be separated by intermediate components, elements, or communication media, one or more of which may modify, manipulate, or carry the electrical signals. The term “on” means directly supported by an element or indirectly supported by the element through another element that is integrated into or supported by the element.

Additional objects, advantages and novel features of the examples will be set forth in part in the following description, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

Nocturnal light is one of the hallmarks of human presence on the earth. At night, lights from places like homes, office buildings, streetlamps, airports, and vehicles provide a meaningful indicator of human activity. Nighttime lights data captured by satellites is useful as a proxy for estimating socio-economic activity.

High-resolution nighttime images and datasets may be gathered by satellites or by instruments onboard a variety of other manned or unmanned sources, such as spacecraft, aircraft, drones, high-altitude balloons and platforms.

The satellites of the Defense Meteorological Satellite Program (DMSP) capture nighttime lights imagery. A scientific instrument known as the Visible Infrared Imaging Radiometer Suite (VIIRS) has been capturing high-resolution nighttime lights data since about 2011 from onboard a polar-orbiting satellite of the Suomi NPP and other satellites. Compared to the DMSP, the data captured by the VIIRS instrument has a higher spatial resolution (i.e., the surface area captured in a single pixel) and a wider radiometric detection range. The VIIRS instrument collects data in more than twenty spectral bands and its day-night band (DNB) has a lower detection threshold than the DMSP system, which means the VIIRS instrument can detect relatively dimmer light sources on the ground.

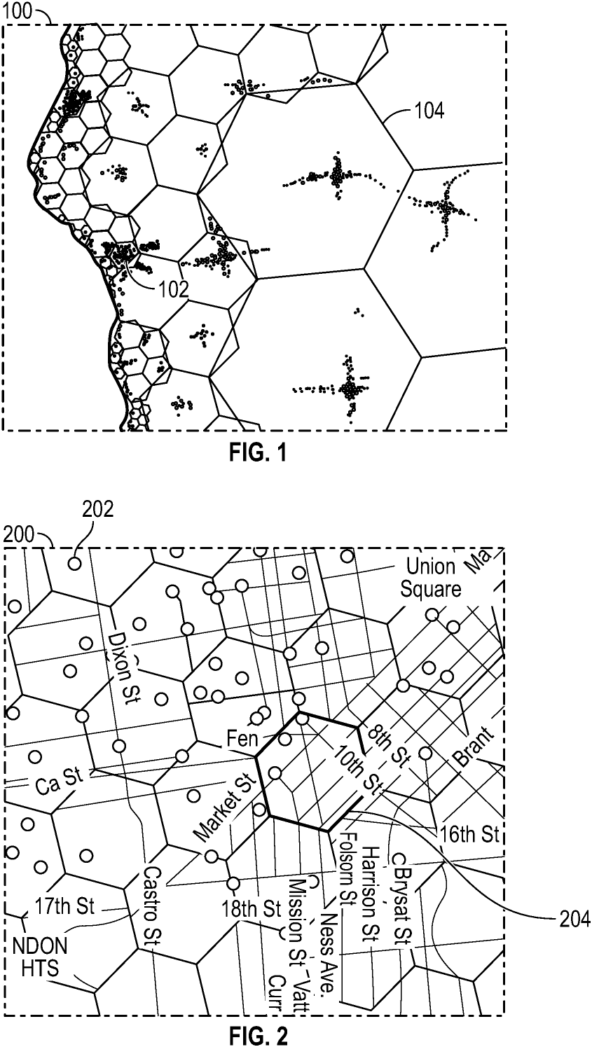

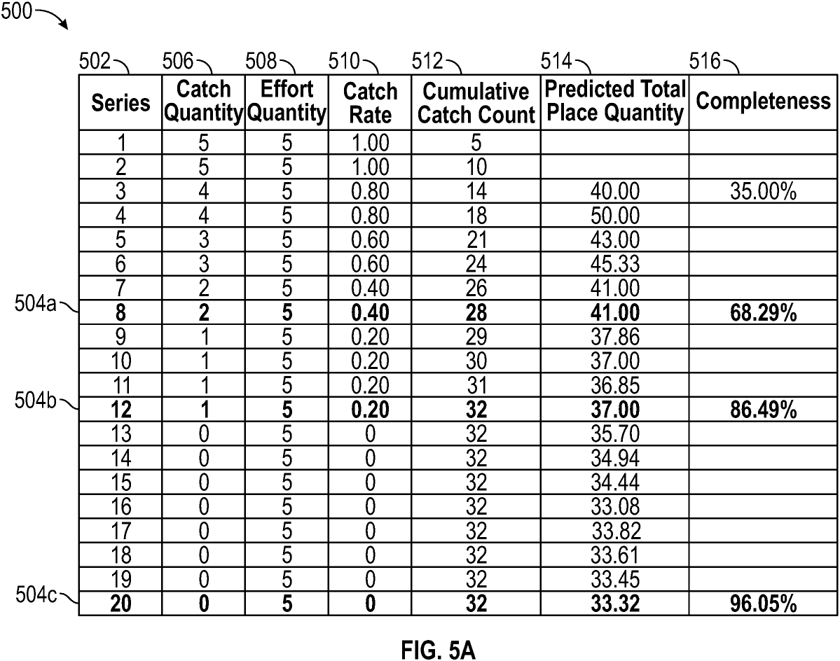

A satellite image captured at night, of course, would include a generally dark field and lights of varying intensity. FIG. 1 is an example illustration of a satellite image 100, displayed for clarity using photographic inversion (e.g., the originally dark pixels appear white; the lighter pixels appear black). As shown, the nighttime lights are relatively dense in populous regions along the coast, and relatively sparse inland. The illustration in FIG. 1 also includes an overlay of contiguous polygonal (e.g., hexagonal) cells or regions generated by a geospatial indexing model (FIG. 4). These hexagonal regions are generally contiguous, meaning they fit together closely with little or no gaps; however, some regions may be partially overlapping. As shown, the hexagonal regions may vary in size, with smaller hexagons applied to more densely populated areas (e.g., populous regions 102 near the coast) and larger hexagons applied to other regions 104. In some implementations, a geospatial indexing model that is suitable for the region-based systems and methods described herein is based on or includes the H3 grid-based spatial indexing system developed by Uber Technologies, Inc. Other digital surface models may be obtained from the U.S. Geological Survey, the U.S. Interagency Elevation Inventory, and NOAA.

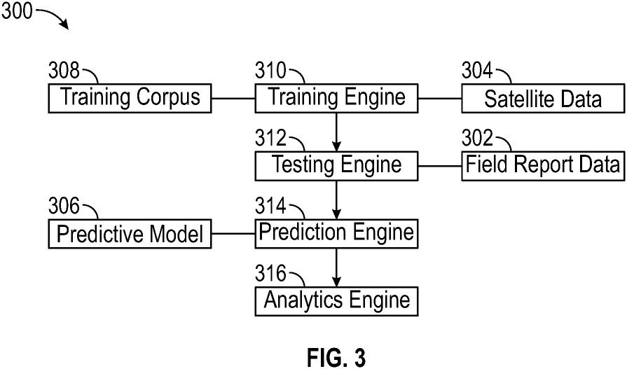

FIG. 2 is an example city map 200 partitioned into a plurality of contiguous regions 204. The map, as shown, includes a plurality of dots, each representing a field report 202 about a point of interest or place. These example hexagonal regions generated by a geospatial indexing model (e.g., the H3 system) are generally contiguous, with little or no overlapping, and generally uniform in size.

In an example context of map-related mobile applications, a user may submit a field report 202 about a new place (e.g., an Add action type) or about an existing place (e.g., an Edit action type). In some applications, the format of a field report 202 includes place data that is limited to a predefined set of attributes, some of which are expected to be relatively static over time (e.g., name, address, business type, telephone number) while others are subject to change or dynamic (e.g., admission policies, hours of operation, amenities). A field report 202 submitted by a user, for example, includes a data submission or label (e.g., cafe) associated with a particular attribute (e.g., business type). The field report 202 need not include a label for each and every attribute. For example, an Edit action may include a single label associated with one attribute of a place. An Add action may include labels for most or all the attributes about a place.

In some example implementations, a field report 202 includes a user identifier, a place identifier, a submission timestamp, and an action type. In some implementations, the action types include Add (e.g., submitting a field report 202 for a new place) or Edit (e.g., submitting a field report 202 including one or more suggested edits, changes, corrections, or other data about one or more place attributes associated with a place that was previously added), as well as other action types.

Users and participating businesses want place data that reflects the objective ground truth; in other words, place data that is accurate, reliable, and up to date. Ground truth place data can be sought by purchasing proprietary third-party datasets or by sending expert investigators into the field. Hiring expert content moderators to investigate takes time and adds expense. Of particular interest is whether the data about places and points of interest in a particular geographic area or region is complete. In other words; to what extent does our data include at least one field report about every place in the region? Crowdsourced data is inherently arbitrary and, therefore, resistant to analysis using sampling correction methodologies that are sometimes applied to more structured survey data. Ground truth place data might include the total number of places in a region; however, that total is subject to change over time as places open and close. The systems and methods described herein, in one aspect, estimate the completeness of crowdsourced place data without relying on an external or objective source of ground truth place data.

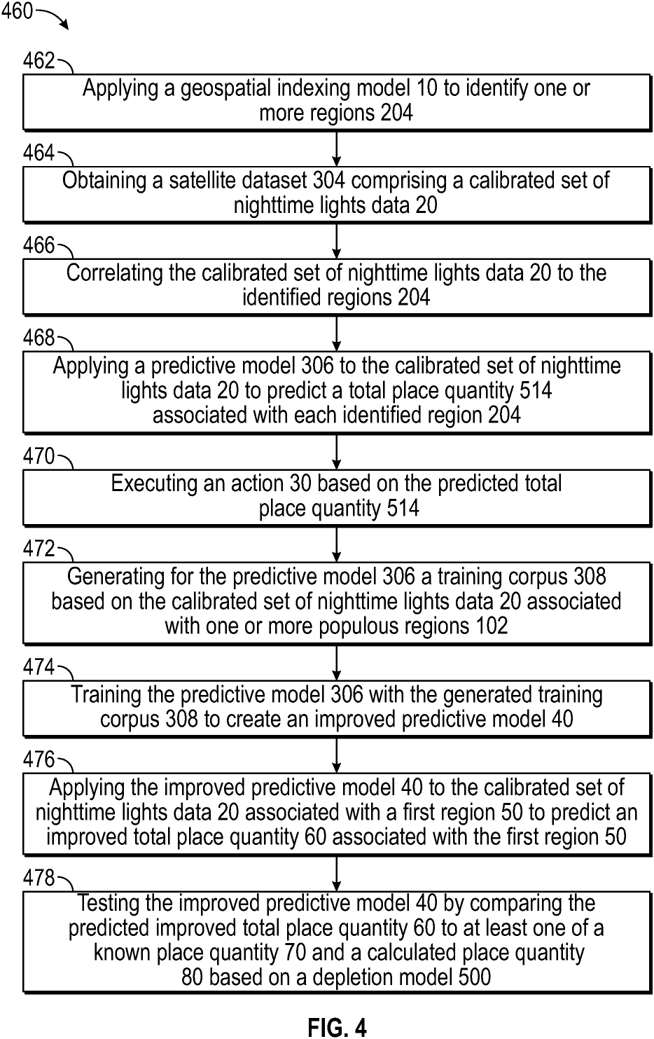

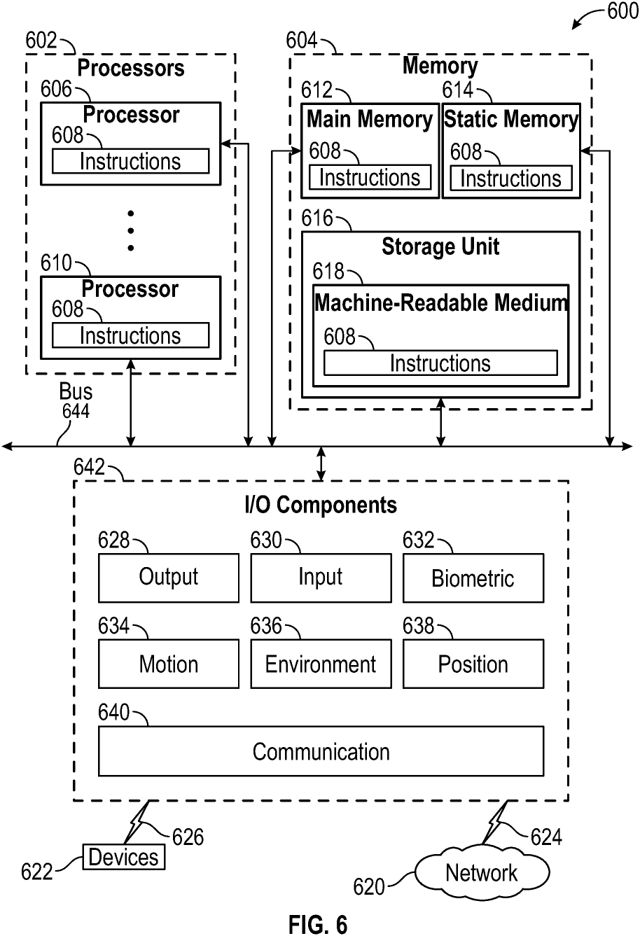

Field reports 202 may be stored in a memory 604 of one or more computing devices 600 (FIG. 6), such as those described herein. Field report data 302 (FIG. 3) in some implementations is stored in a field report database or set of relational databases.

Similarly, an incoming satellite dataset 304, as described herein, may be stored in a memory 604 of one or more computing devices 600. Satellite data 304 in some implementations is stored in a satellite database or set of relational databases.

In some implementations, a place quantity prediction system 300 and methods described herein use field report data 302 and satellite data 304. FIG. 3 is a diagram illustrating an example place quantity prediction system 300 of operatively coupled elements, including a training engine 310, a testing engine 312, a prediction engine 314, and an analytics engine 316. In this example, the training engine 310 is in communication with satellite data 304. The testing engine 312 is in communication with field report data 302. Various programming languages can be employed to facilitate processing of the applications. For example, R is a programming language that is particularly well suited for statistical analysis, data mining, and machine learning supervision.

The satellite dataset 304 in some implementations includes a plurality of satellite images and data gathered by onboard instruments. Each image or dataset is associated with a recording time and a geolocation of the satellite at the recording time (when the image or data was captured). The geolocation data is useful in correlating the captured images and data to ground surface maps. For example, a geolocation file may include latitude, longitude, surface elevation relative to mean sea level, distance to satellite, satellite zenith angle, satellite azimuth angle, solar zenith angle, solar azimuth angle, lunar zenith angle, and lunar azimuth angle.

Nighttime lights can be observed in the images captured during the hours of darkness. In some implementations, the satellite dataset 304 includes a calibrated set of nighttime lights data 20 (FIG. 4). The set 20 is referred to as calibrated because the light data in raw images is typically corrected to more accurately represent the light generated by human activity. For example, the light data in raw satellite images includes lunar light, zodiacal light, volcanoes, wildfires, biomass burning, gas flares at industrial facilities, lightning strikes, surface reflectance (e.g., reflected light from clouds, bodies of water, ice, and snow cover), and atmospheric scattering, as well as interference from smoke, smog, dust, cloud cover, and other meteorological phenomena. A number of software products and algorithms, for example, have been developed which transform the raw data captured by satellites, such as the VIIRS instrument, and thereby generate a calibrated set of nighttime lights data 20.

Even when calibrated using sophisticated algorithms, the daily calibrated sets 20 may include a high degree of variability (e.g., due to lunar phases, weather, and social behavior such as holiday activity, armed conflicts, and migration). In some implementations, the calibrated set of nighttime lights data 20 as used herein includes an average of the daily calibrated sets 20 over an adjustable time period (e.g., two weeks, six months).

FIG. 4 is a flow chart 460 listing the steps in an example method of predicting place quantity by region. Although the steps are described with reference to satellite data, field reports, and place data, other beneficial uses and implementations of the steps described will be understood by those of skill in the art based on the description herein. One or more of the steps shown and described may be performed simultaneously, in a series, in an order other than shown and described, or in conjunction with additional steps. Some steps may be omitted or, in some applications, repeated.

Block 462 in FIG. 4 describes an example step of applying a geospatial indexing model 10 to identify one or more regions 204 on the surface of the earth. As shown in FIG. 2, the regions 204 are generally contiguous and may vary in size, including populous regions 102 and other regions 104. The process of applying a geospatial indexing model 10, in some implementations, defines each identified region 204 according to one or more fixed geolocations (e.g., a latitude, longitude, and surface elevation) associated with one or more vertices or corners of the region 204.

Block 464 in FIG. 4 describes an example step of obtaining a satellite dataset 304 that is associated with at least a portion of the identified regions 204. Satellite datasets 304 generated by various systems are typically available for download, in subsets according to the region of the earth covered by each scan or set of scans. The obtained satellite dataset 304 may include data about all or a portion of any number of identified regions 204 of particular interest. The obtained satellite dataset 304 in some implementations includes a calibrated set of nighttime lights data 20. In some implementations, a calibrated set of nighttime lights data 20 includes a radiance value for each pixel of data gathered by the day-night band (DNB) of the VIIRS instrument, calibrated to more accurately reflect human activity as described herein.

The VIIRS instrument is a scanning radiometer that collects data in twenty-two different spectral bands of the electromagnetic spectrum, in wavelengths between about 0.41 and 12.0 micrometers (µm or 10⁻⁶ meters). The VIIRS instrument includes five high-resolution imagery channels (“I bands”), sixteen moderate-resolution channels (“M bands”), and a day-night band (“DNB”) which gathers nighttime lights data.

The VIIRS instrument scans a swath of the surface of the earth that is about 3,040 kilometers by 12 kilometers. A granule of data includes forty-eight scans, covering about 3,040 km by 576 km (i.e., 12 km per scan times 48 scans). The raw data is typically processed and stored in a single file (e.g., about 2 GB typically) for each granule.

The day-night band (DNB) has a spatial resolution of about 740 by 740 meters, which is nearly consistent across the width of the scan, from the nadir (i.e., the point directly below the satellite) to the edges. In other words, each pixel of data gathered by the DNB covers about 740 by 740 meters. A granule of data, therefore, includes about 778 by 4,108 pixels (or nearly 3.2 million) pixels of DNB data.

The DNB data includes a detected radiance value for each pixel. The SI unit of radiance is watts per steradian per square meter. For each pixel in the DNB data, the uncalibrated radiance values (in one example dataset) ranged from about -1.40 to about 32,640 nanowatts (nW or 10⁻⁹ watts) per steradian (sr) per square centimeter (cm²).

A calibrated set of nighttime lights data 20 in some implementations includes a radiance value per pixel which has been transformed, corrected, or otherwise modified to more accurately represent the light generated by human activity. For example, a small portion of the uncalibrated radiance values are negative (e.g., -1.40 nW/sr/cm²). The process of calibration in some implementations includes setting the lowest value to zero and adjusting the non-zero values accordingly. Moreover, as described herein, the process of calibration in some implementations includes removing the influence of non-human activity (e.g., lunar light, wildfires, lightning, and weather). In one example, a statistical evaluation generated a set of calibrated set of nighttime lights data 20 for the scans associated with the country of Colombia in which the radiance values ranged from nearly zero in remote regions to about 810 nW/sr/cm² in relatively populous regions.

Block 466 in FIG. 4 describes an example step of correlating the calibrated set of nighttime lights data 20 to the identified regions 204. Using the geolocation data, the numerous scans in the obtained satellite dataset 304 are associated with one or more of the regions 204 as identified by the geospatial indexing model 10. In some implementations the satellite dataset 304, including the calibrated set of nighttime lights data 20, is stored in the satellite data 304 shown in FIG. 3. The process of correlating in some implementations includes identifying and extracting that portion of the calibrated set of nighttime lights data 20 which corresponds to the fixed geolocations of each identified region 204.

In the context of the VIIRS instrument, a granule of data includes forty-eight scans, covering about 3,040 km by 576 km. Each granule of VIIRS data includes geolocation data (e.g., latitude, longitude, surface elevation, etc.) as described herein. Each identified region 204 has one or more fixed geolocations (e.g., a latitude, longitude, and surface elevation) associated with one or more corners of the polygonal region 204. The process of correlating the calibrated set of nighttime lights data 20 to the identified regions 204 in some implementations includes comparing the VIIRS geolocation data to the fixed geolocations associated with each identified region 204. In this aspect, the radiance values for each pixel (i.e., for each area of 740 by 740 meters on the surface) in the calibrated set of nighttime lights data 20 is correlated to the areas defined by the fixed geolocations of the identified regions 204. Because the regions 204 may vary in size, as shown in FIG. 2, the VIIRS radiance value for a single pixel might cover several relatively small regions (e.g., with edges less than 740 meters). Conversely, the VIIRS radiance values for several pixels might be required to cover a relatively large region.

In one example study, the continent of Africa was divided into about 2,747 cells of generally equal size. The calibrated set of nighttime lights data 20 from the VIIRS data was correlated to the example cells. The resulting radiance values ranged from about 0.047 nW/sr/cm² in remote cells to about 297,024 nW/sr/cm² in more densely populated cells.

Block 468 in FIG. 4 describes an example step of applying a predictive model 306 to the calibrated set of nighttime lights data 20 to predict a total place quantity 514 associated with each identified region 204. As shown in FIG. 3, the predictive model 306 in some implementations is in communication with the prediction engine 314 of the place quantity prediction system 300. The process of applying a predictive model 306 in some implementations is accomplished by the prediction engine 314.

Block 470 in FIG. 4 describes an example step of executing an action 30 based on the predicted total place quantity 514. The step of executing an action 30 in some implementations is controlled by the analytics engine 316 (FIG. 3). The executed action 30 in some implementations includes storing the predicted total place quantity 514 or replacing a previously stored value with the predicted total place quantity 514. The executed action 30 in some implementations includes estimating a completeness value 516 associated with each region (e.g., a ratio of the known or stored place quantity to the predicted total place quantity 514).

The executed action 30 in some implementations includes establishing a market value associated with each region. As used herein, the market value may represent or be associated with advertising rates (e.g., for business partners who wish to advertise to users in a region), placement offers (e.g., charging a fee for curating or otherwise submitting an Add-type field report about a particular point of interest or place within the region), user incentives (e.g., bonus points, prizes, credits, or cash offered to users who submit an Add-type field report about a place within the region, to encourage a higher catch quantity 506, for example), or for other business or strategic purposes. For owners of business places or other points of interest, in this context, the estimated completeness 516 affects the perceived market value associated with the reaching out to users in a region 204. For example, a relatively high estimated completeness 516 represents a region 204 that is likely saturated with active users, which may or may not be a good fit with the goals of business owners. A relatively low estimated completeness 516 may represent a region 204 that is just beginning to attract more active users, which may be an opportunity to reach out to such users with incentives, offers, or promotions.

Referring again to block 468, the predictive model 306 in some implementations includes one or more machine learning algorithms.

Machine learning refers to algorithms that improve incrementally through experience. By processing a large number of different input datasets, a machine-learning algorithm can develop improved generalizations about particular datasets, and then use those generalizations to produce an accurate output or solution when processing a new dataset. Broadly speaking, a machine-learning algorithm includes one or more parameters that will adjust or change in response to new experiences, thereby improving the algorithm incrementally; a process similar to learning.

Mathematical models are used to describe the operation and output of complex systems. A mathematical model may include a number of governing equations designed to calculate a useful output based on a set of input conditions, some of which are variable. A strong model generates an accurate prediction for a wide variety of input conditions. A mathematical model may include one or more algorithms.

Regression analysis is a set of statistical processes for estimating the relationships between an output or target variable (e.g., a total place quantity 514 for a single region 204) and one or more independent variables (e.g., a calibrated set of nighttime lights data 20 captured over multiple regions, and over multiple time periods). The most common form of regression analysis is linear regression, in which the mathematical model is a linear expression (e.g., y = mx + b) which most closely fits the input data. Regression analysis can also be used when the mathematical model is non-linear. In most kinds of non-linear regression analysis, the data are fitted using a number of successive approximations.

Regression analysis is often used for prediction and forecasting. When the target variable is a real number (e.g., a total place quantity 514), decision trees can be used as part of a regression analysis. Decision tree learning is one of the predictive modeling approaches used in statistics, data mining, and machine learning. The goal of decision trees is to create a mathematical model that predicts the value of a target or output variable (e.g., a total place quantity 514) based on many instances or subsets of the independent input variables.

In the context of machine learning, the goal of decision trees is to incrementally revise, update, and improve a mathematical model so it will more accurately predict the value of a target or output variable (e.g., a total place quantity 514). Random Forest is a supervised, ensemble learning method for conducting regression analysis which operates by constructing a multitude of decision trees. The forest of decision trees is referred to as ‘random’ because the method includes building multiple decision trees by repeatedly re-sampling the input data, with replacement (e.g., the same data point may be used multiple times, in different trees), in a process called bootstrap aggregating. A random forest may include hundreds or thousands of decision trees. Each randomly built tree produces an output value. The final prediction is based on all the output values (e.g., a mean or average value).

In some implementations, the predictive model 306 includes at least one random forest machine-learning algorithm. The process of building and training the predictive model 306 includes creating at least one random forest of decision trees, each generating an output value (e.g., a place quantity based on a single decision tree). The predicted total place quantity 514 is based on all the generated output values (e.g., a mean or average of the tree-generated output values).

In use, the random forest algorithm of the predictive model 306 is particularly well suited for analyzing calibrated set of nighttime lights data 20 captured over multiple regions. The random nature of the data sampling produces a robust mathematical model. Moreover, the random forest algorithm includes methods for evaluating the accuracy of the results. In this aspect, the set of decision trees which produces the most accurate results can be identified and selected for use in a trained or otherwise improved random-forest predictive model.

Block 472 in FIG. 4 describes an example step of generating for the predictive model 306 a training corpus 308 based on a calibrated set of nighttime lights data 20 that is associated with at least one populous region 102. The process of generating a training corpus 308 in some implementations is accomplished by the training engine 310 which, as shown in FIG. 3, is in communication with the satellite data 304.

In some implementations, the process of generating a training corpus 308 includes selecting one or more populous regions 102 and retrieving the calibrated set of nighttime lights data 20 associated with each selected populous region 102 - and repeating this process periodically, as new data becomes available, to iteratively update and improve the training corpus 308. In general, but not always, a populous region 102 with relatively large amounts of place data generates a relatively robust training corpus 308 that is particularly useful for training a predictive model 306.

As used herein, a populous region 102 means and includes a region 204 having a relatively high number of confirmed places or a large number of active users, regardless of the relative number of inhabitants. In general, regions with more inhabitants generate more places, but not always. In this aspect, a populous region 102 may have a high number of active users, while being located in a relatively uninhabited region (e.g., a national park, a remote tourist destination).

As used herein, other region 104 means and includes a region 204 having zero or relatively few confirmed places or a low number of active users, regardless of the relative number of inhabitants. For example, a particular other region 104 may be classified as a ‘user desert’ with very few users, while being located in a relatively populated region (e.g., a densely populated area of a city where relatively few users are participating in the process of adding or editing place data).

Block 474 in FIG. 4 describes an example step of training the predictive model 306 with the generated training corpus 308 to create an improved predictive model 40. The process of training the predictive model 306 in some implementations is accomplished by the training engine 310. In some implementations, the predictive model 306 described herein includes a machine-trained mathematical model (e.g., a mathematical function or set of functions) which will be useful in estimating the total place quantity 514 for a single region 204 (i.e., the output or target variable) based on a calibrated set of nighttime lights data 20 captured over multiple regions (i.e., the input variables). In some implementations, the process of training the predictive model 306 is repeated periodically, as new data becomes available and the training corpus 308 is updated and improved. In this aspect, the process of creating an improved predictive model 402 is generally periodic and ongoing.

Block 476 in FIG. 4 describes an example step of applying the improved predictive model 40 to a calibrated set of nighttime lights data 20 that is associated with a first region 50 for the purpose of predicting an improved total place quantity 60 associated with the first region 50. In some implementations, the first region is one of the other regions 104. In this example, the improved predictive model 40 has been trained using data from a pulpous region 102 in order to generate a prediction for the first region 50 (e.g., one of the less-populous other regions 104).

Block 478 in FIG. 4 describes an example step of testing the improved predictive model 40 and generating an accuracy value based on the testing. The process of testing the improved predictive model 402 in some implementations is accomplished by the testing engine 312.

In some implementations, the process of testing the improved predictive model 40 and generating an accuracy value includes comparing the predicted improved total place quantity 60 to a known place quantity 70 associated with at least one of the populous regions 102. For example, as shown in FIG. 3, the testing engine 312 in some implementations is in communication with a store of field report data 302, which may include a known place quantity 70 (e.g., fifty place identifiers) associated with at least one of the populous regions 102 (e.g., region A). In this example, the process includes comparing the predicted improved total place quantity 60 (e.g., thirty places) to the known place quantity 70 (e.g., fifty place identifiers) and generating an accuracy value (e.g., sixty percent) for the improved predictive model 40.

As used herein, the known place quantity 70 means and includes a value selected because it represents the objective true number of places in a particular region. For example, a known place quantity 70 may be a value in a proprietary third-party dataset, a value curated by persons with special knowledge (e.g., experts, field investigators, content moderators), a value based on trustworthy crowdsourced data, or a value derived from a combination of any or all such sources.

In some implementations, the process of testing the improved predictive model 40 includes comparing the predicted improved total place quantity 60 to a calculated place quantity 80 associated with at least one of the populous regions 102. In some implementations, the calculated place quantity 80 is based on a depletion model that has been applied to a subset of field reports 500.

FIG. 5A is an example subset 500 of field reports, tabulated as a series 502 of data records 504 (e.g., numbered 1 through 20) suitable for analysis by an example depletion model. Each record includes the data related associated with the field reports 202 received during a particular time increment (e.g., a twenty-four-hour period). In some implementations, as shown, the data includes a catch quantity 506, an effort quantity 508, a calculated catch rate 510, a cumulative catch count 512, a predicted total place quantity 514, and a completeness 516.

In some implementations, the catch quantity 506 includes, for each record 504, a count of the number of Add-type field reports (e.g., submitting a field report 202 for a new place). The catch quantity 506 in this aspect represents the number of new place Adds submitted by users in the region 204 during the time period associated with each record 504. The effort quantity 508 represents a total number of field reports 202 (e.g., all types, including Adds and Edits). The effort quantity 508 in this aspect represents an estimate of the total field-report activity by users in the region 204 during the time period associated with each record 504. The calculated catch rate 510 represents the catch quantity 506 (e.g., the Add report types) compared to the effort quantity 508 (e.g., all reports) associated with each record 504. The catch rate 510 in some implementations is calculated by the catch quantity 506 divided by the effort quantity 508 (e.g., expressed as a ratio or a percentage). For example, for record 504a in FIG. 5A, the catch rate 510 is two, the effort quantity 508 is five, and the catch rate 510 is two divided by five; expressed as 0.40 or 40%.

The depletion model in some implementations is a linear regression model which, when applied to a series 502 of data records as shown in FIG. 5A, generates a linear function that is based on the calculated catch rate 510 and the maintained cumulative catch count 512. The depletion model in some implementations is applied as part of a system for predicting the total place quantity 514 and estimating a completeness 516 associated with a region 204. The predicted total place quantity 514 in some implementations is based on the catch rate 510 and the cumulative catch count 512 associated with the prediction record 504a. As shown in FIG. 5A, as more and more field reports 202 are submitted about a particular region, the number of new places added (i.e., the catch quantity 506) over time will approach zero (e.g., when there are few or no additional places to be added). Accordingly, as the catch quantity 506 decreases, the calculated catch rate 510, over time, will approach zero.

The known data points associated with the prediction record 504c (FIG. 5A) are plotted on the graph in FIG. 5B. As shown, the graph in FIG. 5B is a Cartesian coordinate system showing each data point in FIG. 5A as a hollow dot, in which the abscissa value along the x-axis is the cumulative catch count 512 and the ordinate value along the y-axis is the calculated catch rate 510. The plotted data points show that the calculated catch rate 510 is trending toward zero as the cumulative catch count 512 increases.

Curve fitting describes the process of constructing a curve or finding a mathematical function that best fits a series of known data points. In statistics, a linear regression model assumes that the best-fit mathematical function is linear. A linear regression model fits a line to the known data points. The resulting linear function has the form y = mx + b, where m is the slope of the line and b is the y-intercept value (i.e., the value of y when the line crosses the y-axis (for x equals zero)). For a given linear function, the x-intercept value (i.e., the value of x when the line crosses the x-axis) can be calculated by setting y equal to zero and solving for x.

The graph in FIG. 5B includes a line 550 plotted according to an example linear function generated by applying an example depletion model 500 to the known data points associated with the prediction record 504c in FIG. 5A. As shown, the calculated catch rate 510 equals zero and the cumulative catch count 512 equals thirty-two for a total of eight records leading up to and including the prediction record 504c. These eight data points are overlapping and therefore shown in FIG. 5B as a collection of concentric dots, located at x-y coordinates (32, 0) on the graph. The predicted total place quantity 514 associated with record 504c equals 33.32 - which is illustrated graphically as the x-intercept value (i.e., the value of x when the line 550 crosses the x-axis).

Referring again to block 478 in FIG. 4, the process of testing the improved predictive model 402 in some implementations includes comparing the predicted improved total place quantity 60 to a calculated place quantity 80 (e.g., the predicted total place quantity 514 equal to 33.32), which is based on a depletion model applied to a subset 500 of field reports 202. In this example, the process includes comparing the predicted improved total place quantity 60 (e.g., thirty places) to the calculated place quantity 80 (e.g., 33.32 places) and generating an accuracy value (e.g., thirty divided by 33.32, or 99.03%) for the improved predictive model 40.

Referring again to FIG. 3, the place quantity prediction system 300 includes a memory that stores instructions and a processor configured by those stored instruction to perform operations, such as the method steps described herein. The place quantity prediction system 300 of operatively coupled elements includes, in some implementations, a training engine 310, a testing engine 312, a prediction engine 314, and an analytics engine 316. In this example configuration, the training engine 310 is in communication with a training corpus 308 and satellite data 304. The testing engine 312 is in communication with field report data 302. The prediction engine 314 is in communication with a predictive model 306.

FIG. 6 is a diagrammatic representation of a machine 600 within which instructions 608 (e.g., software, a program, an application, an applet, an app, or other executable code) for causing the machine 600 to perform any one or more of the methodologies discussed herein may be executed. For example, the instructions 608 may cause the machine 600 to execute any one or more of the methods described herein. The instructions 608 transform the general, non-programmed machine 600 into a particular machine 600 programmed to carry out the described and illustrated functions in the manner described. The machine 600 may operate as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 608, sequentially or otherwise, that specify actions to be taken by the machine 600. Further, while only a single machine 600 is illustrated, the term “machine” shall also be taken to include a collection of machines that individually or jointly execute the instructions 608 to perform any one or more of the methodologies discussed herein.

The machine 600 may include processors 602, memory 604, and input/output (I/O) components 642, which may be configured to communicate with each other via a bus 644. In an example, the processors 602 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 606 and a processor 610 that execute the instructions 608. The term “processor” is intended to include multi-core processors that may comprise two or more independent processors (sometimes referred to as “cores”) that may execute instructions contemporaneously. Although multiple processors 602 are shown, the machine 600 may include a single processor with a single core, a single processor with multiple cores (e.g., a multi-core processor), multiple processors with a single core, multiple processors with multiples cores, or any combination thereof.

The memory 604 includes a main memory 612, a static memory 614, and a storage unit 616, both accessible to the processors 602 via the bus 644. The main memory 604, the static memory 614, and storage unit 616 store the instructions 608 embodying any one or more of the methodologies or functions described herein. The instructions 608 may also reside, completely or partially, within the main memory 612, within the static memory 614, within machine-readable medium 618 (e.g., a non-transitory machine-readable storage medium) within the storage unit 616, within at least one of the processors 602 (e.g., within the processor’s cache memory), or any suitable combination thereof, during execution thereof by the machine 600.

Furthermore, the machine-readable medium 618 is non-transitory (in other words, not having any transitory signals) in that it does not embody a propagating signal. However, labeling the machine-readable medium 618 “non-transitory” should not be construed to mean that the medium is incapable of movement; the medium should be considered as being transportable from one physical location to another. Additionally, since the machine-readable medium 618 is tangible, the medium may be a machine-readable device.

The I/O components 642 may include a wide variety of components to receive input, provide output, produce output, transmit information, exchange information, capture measurements, and so on. The specific I/O components 642 that are included in a particular machine will depend on the type of machine. For example, portable machines such as mobile phones may include a touch input device or other such input mechanisms, while a headless server machine will likely not include such a touch input device. It will be appreciated that the I/O components 642 may include many other components that are not shown. In various examples, the I/O components 642 may include output components 628 and input components 630. The output components 628 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, a resistance feedback mechanism), other signal generators, and so forth. The input components 630 may include alphanumeric input components (e.g., a keyboard, a touch screen configured to receive alphanumeric input, a photo-optical keyboard, or other alphanumeric input components), pointing-based input components (e.g., a mouse, a touchpad, a trackball, a joystick, a motion sensor, or another pointing instrument), tactile input components (e.g., a physical button, a touch screen that provides location, force of touches or touch gestures, or other tactile input components), audio input components (e.g., a microphone), and the like.

In further examples, the I/O components 642 may include biometric components 632, motion components 634, environmental components 636, or position components 638, among a wide array of other components. For example, the biometric components 632 include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 634 include acceleration sensor components (e.g., accelerometer), gravitation sensor components, rotation sensor components (e.g., gyroscope), and so forth. The environmental components 636 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 638 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 642 further include communication components 640 operable to couple the machine 600 to a network 620 or devices 622 via a coupling 624 and a coupling 626, respectively. For example, the communication components 640 may include a network interface component or another suitable device to interface with the network 620. In further examples, the communication components 640 may include wired communication components, wireless communication components, cellular communication components, Near-field Communication (NFC) components, Bluetooth° components (e.g., Bluetooth® Low Energy), Wi-Fi® components, and other communication components to provide communication via other modalities. The devices 622 may be another machine or any of a wide variety of peripheral devices (e.g., a peripheral device coupled via a USB).

Moreover, the communication components 640 may detect identifiers or include components operable to detect identifiers. For example, the communication components 640 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 640, such as location via Internet Protocol (IP) geolocation, location via Wi-Fi® signal triangulation, location via detecting an NFC beacon signal that may indicate a particular location, and so forth.

The various memories (e.g., memory 604, main memory 612, static memory 614, memory of the processors 602), storage unit 616 may store one or more sets of instructions and data structures (e.g., software) embodying or used by any one or more of the methodologies or functions described herein. These instructions (e.g., the instructions 608), when executed by processors 602, cause various operations to implement the disclosed examples.

The instructions 608 may be transmitted or received over the network 620, using a transmission medium, via a network interface device (e.g., a network interface component included in the communication components 640) and using any one of a number of well-known transfer protocols (e.g., hypertext transfer protocol (HTTP)). Similarly, the instructions 608 may be transmitted or received using a transmission medium via the coupling 626 (e.g., a peer-to-peer coupling) to the devices 622.

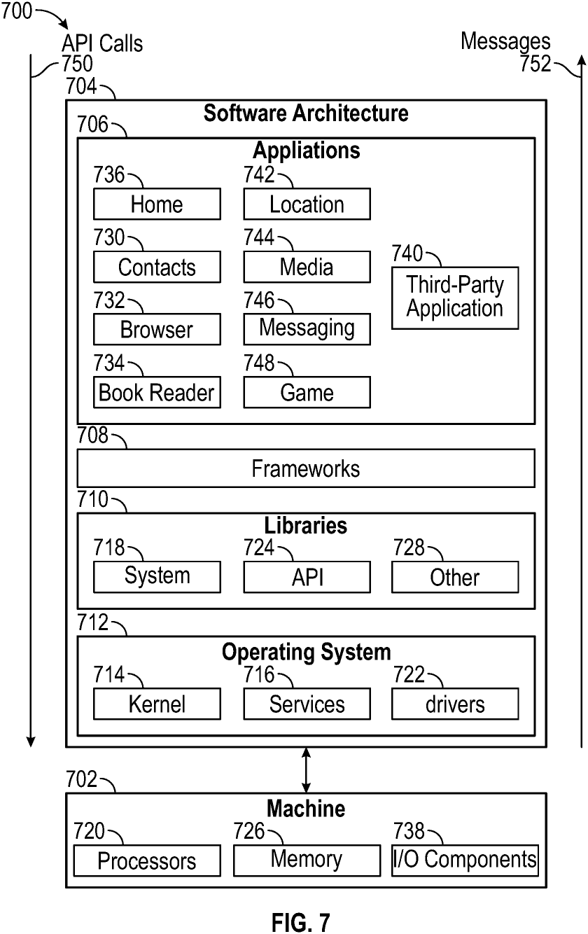

FIG. 7 is a block diagram 700 illustrating a software architecture 704, which can be installed on any one or more of the devices described herein. The software architecture 704 is supported by hardware such as a machine 702 that includes processors 720, memory 726, and I/O components 738. In this example, the software architecture 704 can be conceptualized as a stack of layers, where each layer provides a particular functionality. The software architecture 704 includes layers such as an operating system 712, libraries 710, frameworks 708, and applications 706. Operationally, the applications 706 invoke API calls 750 through the software stack and receive messages 752 in response to the API calls 750.

The operating system 712 manages hardware resources and provides common services. The operating system 712 includes, for example, a kernel 714, services 716, and drivers 722. The kernel 714 acts as an abstraction layer between the hardware and the other software layers. For example, the kernel 714 provides memory management, processor management (e.g., scheduling), component management, networking, and security settings, among other functionalities. The services 716 can provide other common services for the other software layers. The drivers 722 are responsible for controlling or interfacing with the underlying hardware. For instance, the drivers 722 can include display drivers, camera drivers, Bluetooth® or Bluetooth® Low Energy (BLE) drivers, flash memory drivers, serial communication drivers (e.g., Universal Serial Bus (USB) drivers), Wi-Fi® drivers, audio drivers, power management drivers, and so forth.

The libraries 710 provide a low-level common infrastructure used by the applications 706. The libraries 710 can include system libraries 718 (e.g., C standard library) that provide functions such as memory allocation functions, string manipulation functions, mathematic functions, and the like. In addition, the libraries 710 can include API libraries 724 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., a WebKit® engine to provide web browsing functionality), and the like. The libraries 710 can also include a wide variety of other libraries 728 to provide many other APIs to the applications 706.

The frameworks 708 provide a high-level common infrastructure that is used by the applications 706. For example, the frameworks 708 provide various graphical user interface (GUI) functions, high-level resource management, and high-level location services. The frameworks 708 can provide a broad spectrum of other APIs that can be used by the applications 706, some of which may be specific to a particular operating system or platform.

In an example, the applications 706 may include a home application 736, a contacts application 730, a browser application 732, a book reader application 734, a location application 742, a media application 744, a messaging application 746, a game application 748, and a broad assortment of other applications such as a third-party application 740. The third-party applications 740 are programs that execute functions defined within the programs.

In a specific example, a third-party application 740 (e.g., an application developed using the Google Android or Apple iOS software development kit (SDK) by an entity other than the vendor of the particular platform) may be mobile software running on a mobile operating system such as Google Android, Apple iOS (for iPhone or iPad devices), Windows Mobile, Amazon Fire OS, RIM BlackBerry OS, or another mobile operating system. In this example, the third-party application 740 can invoke the API calls 750 provided by the operating system 712 to facilitate functionality described herein.

Various programming languages can be employed to create one or more of the applications 1006, structured in a variety of manners, such as object-oriented programming languages (e.g., Objective-C, Java, C++, or R) or procedural programming languages (e.g., C or assembly language). For example, R is a programming language that is particularly well suited for statistical computing, data analysis, and graphics.

Any of the functionality described herein can be embodied in one or more computer software applications or sets of programming instructions. According to some examples, “function,” “functions,” “application,” “applications,” “instruction,” “instructions,” or “programming” are program(s) that execute functions defined in the programs. Various programming languages can be employed to develop one or more of the applications, structured in a variety of manners, such as object-oriented programming languages (e.g., Objective-C, Java, or C++) or procedural programming languages (e.g., C or assembly language). In a specific example, a third-party application (e.g., an application developed using the ANDROID™ or IOS™ software development kit (SDK) by an entity other than the vendor of the particular platform) may include mobile software running on a mobile operating system such as IOS™, ANDROID™, WINDOWS® Phone, or another mobile operating system. In this example, the third-party application can invoke API calls provided by the operating system to facilitate functionality described herein.

Hence, a machine-readable medium may take many forms of tangible storage medium. Non-volatile storage media include, for example, optical or magnetic disks, such as any of the storage devices in any computer devices or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code or data. Many of these forms of computer readable media may be involved in carrying one or more sequences of one or more instructions to a processor for execution.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as plus or minus ten percent from the stated amount or range.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A method, comprising:
applying a geospatial indexing model to identify one or more regions;
obtaining a satellite dataset associated with at least a portion of the identified regions, the obtained satellite dataset comprising a calibrated set of nighttime lights data;
correlating the calibrated set of nighttime lights data to the identified regions;
applying a predictive model to the calibrated set of nighttime lights data to predict a total place quantity associated with each identified region; and
executing an action based on the predicted total place quantity.

2. The method of claim 1, wherein the step of applying the predictive model comprises: creating at least one random forest of decision trees, each generating an output value; and evaluating the predicted total place quantity based on the generated output values.

3. The method of claim 1, wherein the identified one or more regions comprises one or more populous regions and one or more other regions, the method further comprising:
generating a training corpus for the predictive model, wherein the training corpus is based on the calibrated set of nighttime lights data associated with at least one of the populous regions; and
training the predictive model with the generated training corpus to create an improved predictive model.

4. The method of claim 3, wherein at least one of the training corpus and the predictive model is created using at least one random forest of decision trees.

5. The method of claim 3, further comprising:
applying the improved predictive model to the calibrated set of nighttime lights data associated with a first region to predict an improved total place quantity associated the first region.

6. The method of claim 5, further comprising:
testing the improved predictive model by comparing the predicted improved total place quantity to at least one of (a) a known place quantity associated with at least one of the populous regions, or (b) a calculated place quantity associated with at least one of the populous regions, wherein the calculated place quantity is based on a depletion model applied to a subset of field reports; and
generating an accuracy value based on the testing.

7. The method of claim 6, wherein the step of testing further comprises:
generating a linear function according to the depletion model as applied to the subset, wherein the linear function is based on a calculated catch rate and a cumulative catch count; and
predicting the calculated place quantity based on the generated linear function.

8. A system for predicting a total place quantity associated with a region, comprising:
a memory that stores instructions; and
a processor configured by the stored instructions to perform operations comprising the steps of:
applying a geospatial indexing model to identify one or more regions;
obtaining a satellite dataset associated with at least a portion of the identified regions, the obtained satellite dataset comprising a calibrated set of nighttime lights data;
correlating the calibrated set of nighttime lights data to the identified regions;
applying a predictive model to the calibrated set of nighttime lights data to predict a total place quantity associated with each identified region; and
executing an action based on the predicted total place quantity, wherein the action comprises at least one of storing the predicted total place quantity, estimating a completeness, or establishing a market value.

9. The system of claim 8, wherein the processor is configured by the stored instructions to apply the predictive model by performing operations comprising:
creating at least one random forest of decision trees, each generating an output value; and
evaluating the predicted total place quantity based on the generated output values.

10. The system of claim 8, wherein the identified one or more regions comprises one or more populous regions and one or more other regions, and wherein the processor is configured by the stored instructions to perform further operations comprising:
generating with a training engine a training corpus for the predictive model, wherein the training corpus is based on the calibrated set of nighttime lights data associated with at least one of the populous regions; and
training the predictive model with the generated training corpus to create an improved predictive model.

11. The system of claim 10, wherein at least one of the training corpus or the predictive model is created using at least one random forest of decision trees.

12. The system of claim 10, wherein the processor is configured by the stored instructions to perform further operations comprising:
applying the improved predictive model to the calibrated set of nighttime lights data associated with a first region to predict an improved total place quantity associated the first region, wherein the first region comprises at least one of the one or more other regions.

13. The system of claim 12, wherein the processor is configured by the stored instructions to perform further operations comprising:
testing the improved predictive model with a testing engine by comparing the predicted improved total place quantity to at least one of (a) a known place quantity associated with at least one of the populous regions, or (b) a calculated place quantity associated with at least one of the populous regions, wherein the calculated place quantity is based on a depletion model applied to a subset of field reports; and
generating an accuracy value based on the testing.

14. The system of claim 13, wherein the processor is configured by the stored instructions to test the improved predictive model by performing operations comprising:
generating a linear function according to the depletion model as applied to the subset, wherein the linear function is based on a calculated catch rate and a cumulative catch count; and predicting the calculated place quantity based on the generated linear function.

15. A non-transitory computer-readable medium storing program code which, when executed, is operative to cause an electronic processor to perform the steps of:
applying a geospatial indexing model to identify one or more regions;
obtaining a satellite dataset associated with at least a portion of the identified regions, the obtained satellite dataset comprising a calibrated set of nighttime lights data;
correlating the calibrated set of nighttime lights data to the identified regions;
applying a predictive model to the calibrated set of nighttime lights data to predict a total place quantity associated with each identified region; and
executing an action based on the predicted total place quantity, wherein the action comprises at least one of storing the predicted total place quantity, estimating a completeness, and establishing a market value.

16. The non-transitory computer-readable medium of claim 15, wherein the stored program code which, when executed, is operative to cause an electronic processor to apply the predictive model by performing the steps of:
creating at least one random forest of decision trees, each generating an output value; and
evaluating the predicted total place quantity based on the generated output values.

17. The non-transitory computer-readable medium of claim 15, wherein the identified one or more regions comprises one or more populous regions and one or more other regions, and wherein the stored program code which, when executed, is operative to cause an electronic processor to perform the further steps of:
generating with a training engine a training corpus for the predictive model, wherein the training corpus is based on the calibrated set of nighttime lights data associated with at least one of the populous regions; and
training the predictive model with the generated training corpus to create an improved predictive model.

18. The non-transitory computer-readable medium of claim 17, wherein the stored program code which, when executed, is operative to cause an electronic processor to perform the further steps of:
testing the improved predictive model with a testing engine by comparing the predicted improved total place quantity to at least one of (a) a known place quantity associated with at least one of the populous regions, and (b) a calculated place quantity associated with at least one of the populous regions, wherein the calculated place quantity is based on a depletion model applied to a subset of field reports; and
generating an accuracy value based on the testing.

19. The non-transitory computer-readable medium of claim 17, wherein the stored program code which, when executed, is operative to cause an electronic processor to perform the further steps of:
applying the improved predictive model to the calibrated set of nighttime lights data associated with a first region to predict an improved total place quantity associated the first region.

20. The non-transitory computer-readable medium of claim 18, wherein the stored program code which, when executed, is operative to cause an electronic processor to test the improved predictive model by performing the steps of:
generating a linear function according to the depletion model as applied to the subset, wherein the linear function is based on a calculated catch rate and a cumulative catch count; and predicting the calculated place quantity based on the generated linear function.
